(19) United States
(12) Patent Application Publication
(10) Pub. No.: US 2004/0260724 A1
(43) Pub. Date: Dec. 23, 2004

(54) Method for producing customised thematic data media

(76) Inventor: Pierre Dukan, Paris (FR)

Correspondence Address: GREENBERG TRAURIG, LLP, 885 3RD AVENUE, NEW YORK, NY, 10022, US

(21) Appl. No.: 10/468,414

(22) PCT Filed: Feb. 15, 2002
(86) PCT No.: PCT/FR02/00589

(30) Foreign Application Priority Data
Feb. 19, 2001 (FR) 01/02205

(51) Int. Cl. G06F 7/00

(52) U.S. Cl. 707/104.1

(57) ABSTRACT

A method functioning on the basis of a matrix (2) of predetermined responses that is coupled to a corresponding matrix (3) of multiple-choice questions, and of a database (4) of information associated with said responses and with predetermined combinations of these responses.

In a computer (8) in which said responses and the information (9) from said database are associated, the inputting of responses (5) to the multiple-choice questions on a data terminal (7) by an individual user (6) enables an extraction program (10) to extract from said information database information (11) relating to the responses entered and combinations thereof, and then enables an assembly program (12) to group together the extracted information in order to convert it into the desired information support (1).

Extraction guided by the responses to the questionnaire provides a personalized work.

The present invention relates to a method for producing thematic personalized information supports on the basis of a matrix of predetermined responses that is coupled to a corresponding matrix of multiple-choice questions, and of a database of information associated with said responses and with predetermined combinations of these responses. In a computer in which said responses and said database are associated, the inputting of responses to the multiple-choice questions on a data terminal by an individual user enables an extraction program to extract from said information database information relating to the responses entered and combinations thereof, and then enables an assembly program to group together the extracted information in order to convert it into said information supports.

Hitherto, the conventional version functioned on the basis of a model in which an author composed a work on a particular theme aimed at the widest possible audience and provided general information from which the reader had to extract the elements that related to him and the advice he thought appropriate to his personal situation.

A book of this type, which would aim to be sufficiently comprehensive in order to respond to the questioning of so wide an audience, would require too much time and too high a level of skill for an ordinary reader to go through it in search of information and advice appropriate to his personal situation, and above all could not have made provision for all the combinations of characteristics that alone make any one reader individual. In the conventional design of that version, no book can therefore be both comprehensive enough to cover the fields of all individual requests and retain the size, price, and handleability of an ordinary book. The method according to the invention makes this impossibility achievable, by providing a technical solution allowing a work to be produced on a given theme, the content of which responds strictly to the particular demand of a single reader, provides him with information appropriate to his areas of interest, and provides advice tailored to his identified requirements.

To that end, the invention relates to a method for producing a personalized information support in which:

1) a thematic matrix of groups of predetermined responses is produced;

2) a corresponding matrix of multiple-choice questions is associated with this matrix of groups of responses;

3) a database of information associated with said responses and with the predetermined combinations of these responses is produced;

4) the responses of a person are entered on a data-input terminal associated with said information database;

5) in a computer, said responses and the database information are combined; and

6) from the database information, an extraction program extracts information relating to the responses entered and to combinations thereof; and

7) in the computer, an assembly program groups together the extracted information in order to convert into said information support.

The extraction of the individual characteristics of the reader, tailoring of the information delivered, and the removal of anything that is neutral or not reader-specific allows concentration of the information and advice that make reading thereof easier and allows incorporation thereof into a work of acceptable cost and size.

Through the set of possible responses and the almost infinite multiplicity of combinations thereof, the finished whole is a strictly personal summary that prevents any possibility of two readers having one and the same work.

The solution provided for the invention is based on a number of technical characteristics:

The first of these characteristics is provided by the design and the production of a universal exploratory double matrix composed of a matrix (2) of groups of predetermined responses that is associated. with a corresponding matrix (3) of multiple-choice questions, a research tool that makes it possible to explore all fields of human activity through a number of main research areas such as gender, age, morphology, culture and nationality, history, social life, family situation, employment situation, environment and habitat, intellectual life, creativity, character (emotions, attachments, activities), tastes and preferences, physical appearance, constitution, energy level, food, physical activity, leisure, arts and culture, sexuality, spirituality, health, dependency (alcohol, tobacco), etc.

| Morphology | Physical | Social life | Energy level | Sexuality |
|---|---|---|---|---|
| | activity | | | |
| Physical | Art and | Character | Tastes and | Leisure |
| appearance | culture | | preferences | |
| Dependency | Universal matrix of questions | | | Health |
| Spirituality | Family | Food | Constitution | Habitat and |
| | situation | | | environment |
| | Family life | | | |
| Creativity | Employment | Intellectual | History | Gender, Age, |
| | situation | life | | Nationality, |
| | | | | Culture, |
| | | | | Tradition |

This universal double matrix is capable, after adjustment of its research parameters, of being adapted to exploring any field of human activity.

This adaptation is achieved through selection, exclusion, multiplication or reduction of the number of questions, depending on their relevance to the chosen sector of research.

Adjusted in this way, the association of the question matrix and the response matrix takes the form of a multiple-choice questionnaire specific to the theme chosen.

This multiple-choice questionnaire is filled out by checking the box corresponding to the response chosen from those offered to the reader, whose choices as a whole form his personal selection.

These responses (5) are entered by a person (6) on a data terminal. They may originate from input on a paper form, but also input on a computer or internet site.

Once filled out, this questionnaire makes it possible to define the demand and requirements of any individual whatsoever on any theme or field of human activity regarding which information and self-knowledge enhance the quality of life.

Of the possible thematic fields, mention may be made, by way of examples, of the individual's view of his health, in general or in each of his sectors, his view of his weight, his sexuality, his family, his life partner, the education of his children, his looks, his body and his physical activity, his tobacco dependency, his philosophy on life, his happiness, etc.

In parallel with the questionnaire, the database of information (4) on the chosen theme is produced. This work, done by one or more specialists working in a number of disciplines, consists firstly in compiling an encyclopedic mass of information covering every aspect of the person in question. This exhaustive sum of information will allow a response to each of the questions in the questionnaire on the basis of all the selections of possible responses and, above all, all the predetermined combinations of these responses with one another.

The data terminal 7 from which the responses originate and the information database (4) are independent and may be installed at different locations or coexist within one and the same computer (8), but they must be connected in a computer in order to allow the extraction of the information and the combinations thereof.

The second technical characteristic is provided by the information-extraction program 10.

The function of this program is to relate the responses (5) to the questionnaire and the database (4) containing the information and possible combinations thereof associated therewith in order to extract therefrom direct information (11) and resulting, modulated information based on cross-combination thereof. Guided extraction of the information and relevant combinations weaves the framework of a summary of information and strictly personalized advice.

The information database is composed of three categories of information:

Direct information, without combinations,

either binary, of Yes or No type:

Question: Are you sensitive to the cold? Responses: Yes No,

or qualified on the basis of 3, 4, or 5 or even 6 elements, such as, for example:

Question: Are you satisfied with your physical appearance?

Responses: Yes, Mostly, Mostly not, No

The resulting information, the combination of which with other information modifies or even totally reverses the message. Example:

How much water do you drink per day? Response: 1½ liters.

Without a combination with water retention: Message: Continue drinking that amount.

If there is a combination with water retention:

Message: Stop drinking.

The modulated information, the combination of which with other information is capable of modifying the content thereof. This modulation taking place either with a view to emphasizing the message, information or advice, or with a view to restriction or toning-down.

Functioning of the program (10) for extracting information and relevant combinations.

The function of this program is to extract from the database information (11) relating to the responses entered and combinations thereof.

In order to carry out these operations, the program uses a number of functions in series, passing each item of information extracted from the information database in succession to a pruning area and then to a refining area.

a. The questionnaire is reviewed question by question from first to last.

b. At the request of a question, the program enters the information database and inputs information corresponding to the reader's possible responses with all combinations thereof with other information. Each of these responses is

c. composed of an informative common core that pinpoints the purpose of the question and a number of possible combinations that varies according to the reader.

Let us take a specific example:

Imagine a thematic book on weight control, with a questionnaire composed of 150 questions.

Let us, for example, examine Question 28:

How much water do you drink per day? ½ liter 28a 1 liter 28b 1½ liters 28c

At the request of Question 28, the program enters the information database, and isolates and selects the information and combinations relating to the three possible responses, 28a+28b+28c.

d. The whole is exported to the pruning area where the program will take the reader's response into account. If the reader has responded to Question 28 by checking box 28c, information relating to the non-selected choices 28a and 28b will be eliminated in order to leave only information corresponding to choice 28c.

e. This information block associated with response 28c, with its informative common core and its 5 combinations is then exported to the refining zone.

In this zone, possible combinations with other database information are reviewed and compared to the responses to the questionnaire.

In the example chosen, the information block associated with response 28c 28c comprises:

An informative common core regarding the role of water in the body, its major functions, the various types of water that exist, tastes, presentations, pollution, etc.

A series of possible combinations with other information:

possible coupling with response 2 regarding the reader's gender, i.e. male: 2a or female: 2b

possible coupling with response 45 regarding water retention (isolated) 45a: Yes and 45b: No.

possible coupling with response 47 relating to hot flashes in the days preceding a period (isolated) with its responses 47a: Yes and 47b: No

possible coupling with response [45+47] either associating or not associating retention and hot flashes

possible coupling with response 126 regarding the existence of the pre-menopause with its two possible subresponses: 126a: Yes and 126b: No

The program will then compare these 5 possible combinations with the selection made by the reader and pinpoint the choices giving rise to a combination.

In the preceding example, for Question 2:

In the case of response 2a, the reader is a man, information 2a (female reader) is eliminated and the isolated information 2a (i.e. without another combination) is extracted and may be summarized very succinctly as: “As a man, the hormonal problems that could impede your water circulation do not relate to you, so continue to drink the same amount as this will facilitate your weight loss”.

In the case of response 2b, the reader is a woman, and information 2a (male reader) is eliminated and the isolated information 2b (i.e. without another combination) is extracted and may be summarized very succinctly as: “You are a woman, but you have no water-retention problem, so continue to drink the same amount although you should take care before your period”.

In the case of Question 45,

In the case of response 45b (no water retention), this does not give rise to a combination and information 45b, which is not relevant, is eliminated.

In the case of response 45a (water retention), it is relevant, i.e. it lends itself to a combination and will be retained, and the information delivered may be summarized as: “Woman with tendency toward retention, drink water that is low in minerals, reduce food salt intake, reduce beverage volume, 1 liter of water maximum”.

In the case of Question 47,

In the case of response 47b (no bloating during periods), the selection is irrelevant and information 47 is eliminated.

In the case of response 45a (bloating during periods only), the selection is relevant, i.e. it lends itself to a combination and will be retained, and the information delivered may be summarized as: “Before your period, you are a veritable sponge, no more than ¾ of a liter of water that is low in minerals 5 days per month”.

In the case of 45a+47a selected together.

In the case of responses 45a+47a (retention+bloating during periods), the dual selection is relevant, i.e. it lends itself to a combination and the information delivered may be summarized as: “Not only do you retain water throughout your cycle, but hot flashes increase at the time of your period, 1 liter of water maximum +water that is low in minerals+reduction in salt intake and the last 5 days of your cycle drop to ¾ of a liter+salt-free diet+spend only half an hour standing per day+during night-time, raised-bed feet.

In the case of Question 126,

In the case of response 126b (not pre-menopausal), the selection is irrelevant and information 26 is globally eliminated.

If selection 126a is isolated (pre-menopausal without combination with retention or hot flashes), the selection is relevant, i.e. it lends itself to a combination and will be retained, and the information delivered may be summarized as: “You are at a pre-menopausal stage, you do not yet suffer from retention, be on your guard as this will occur, to be prudent limit yourself to 1 liter of water”.

In the refining area, irrelevant combinations are thus progressively cut out and eliminated. All that remains is the informative core and the relevant combinations retained, which form a sparse body of text.

The last technical characteristic of the invention is provided by the assembly (12) and page-makeup program, a specific device for converting the compilation of prunings into a completed information support (1) of uniform dimensions and presentation.

The assembly and page-makeup program exports each isolated pruning to the assembly area where it is formatted in order to reabsorb the eliminated-information locations, and is then integrated into the body of the information support.

The prunings extracted one by one are grouped together into areas of interest, linked, and subjected to smoothed liaison work, to prevent telescoping and colliding stacks, then assembled as raw text.

This text is then subjected to a page-makeup treatment that adapts its length, which can vary according to the reader, to the established dimensions and space of the chosen information support.

This optimum occupation of the space is rendered possible by virtue of the use, by the assembly program, of specific page makeup and an occupation iconography adapted to the meaning of the text and to the dimensions of the spaces to be covered.

At the end of these operations, the information support (1) obtained may be a paper book, but may just as easily be an electronic book or, more simply, a downloadable computer file.

The appended drawings illustrate the invention:

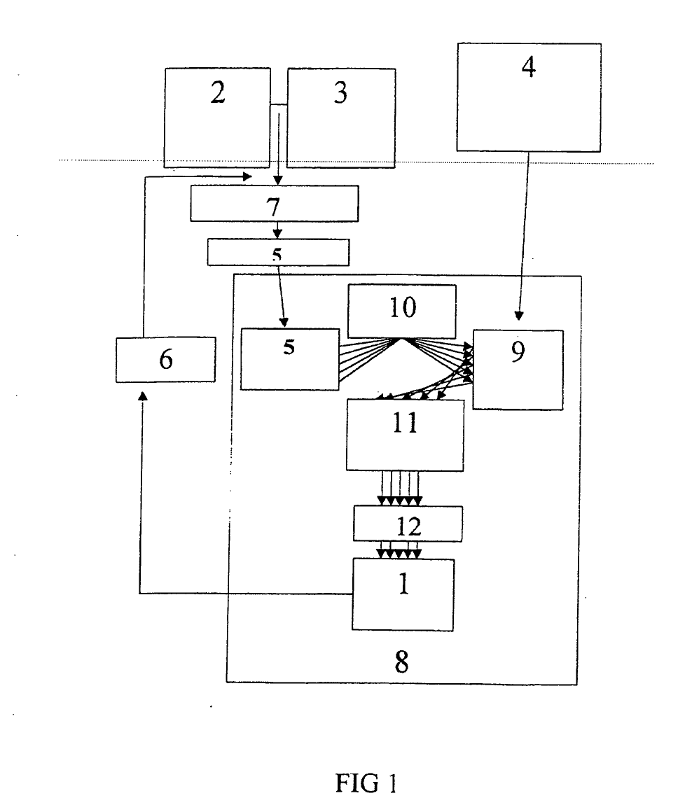

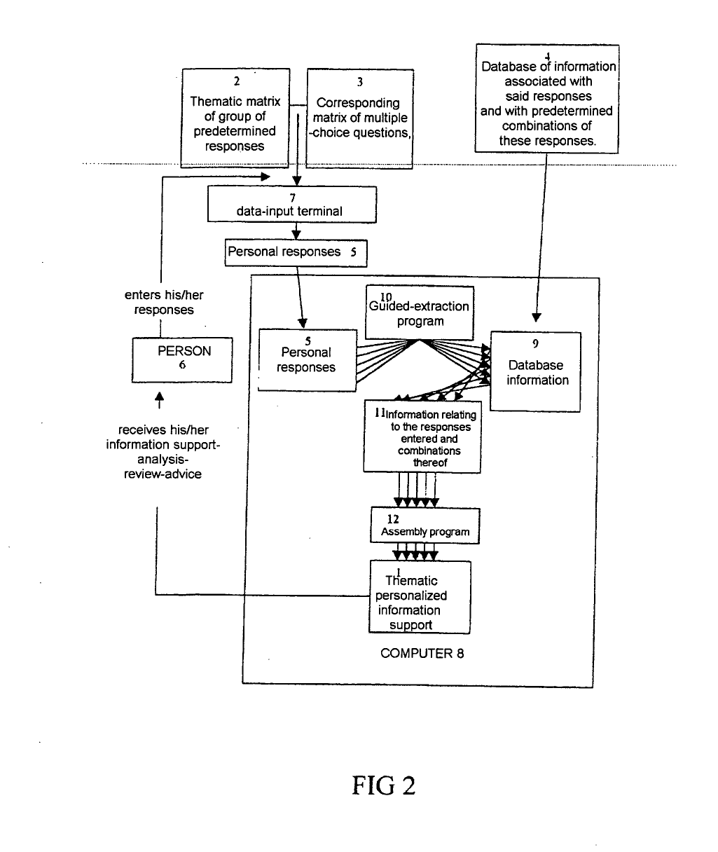

FIG. 1 shows the diagrammatic mode of operation of the invention. It includes the thematic matrix (2) of responses associated with the thematic matrix (3) of questions. The person (6) using the invention enters his or her personal responses (5) by checking the boxes corresponding to his/her choices. These responses end up on a data terminal (7).

In parallel, a database (4) of information associated with the responses of the matrix is constituted.

Personal responses and database information (9) are entered on a computer (8).

The extraction program (10), guided by the personal responses, extracts, from the database information, information (11) relating to the responses entered and combinations thereof.

The extracted information is assembled and given a page format by virtue of an assembly program (12) that makes up the final information support (1) ready for printing or downloading.

According to various embodiments, the personalized thematic information support may deal with most of the relationships that an individual may entertain in the wider areas of practical life.

An example: the view of an individual of his weight.

In this particular case, the information database will be composed of a team of specialists in food, nutritionists, dieticians, specialists in physical exercise or beauty, psychologists.

The general matrix will be adapted to the person in question by means of the adaptation of the main areas of its research parameters, such as inter alia gender, age, nationality, culture, history, social, family and employment situation, character (emotions, attachments, activities), tastes and preferences, physical appearance, constitution, physical activity, sexuality or health, but by eliminating certain questions not relevant to the person in question and, above all, by reorienting and looking in greater depth in the case of certain questions relating to food, social life, any business meals, food at places of work, characteristics of the personality in relation to variations in food behavior, nibbling, appetite, cravings, greed, physical appearance and morphological distribution of fats and the relationship of appearance to sexuality.

Once the questionnaire and the responses have been established, the corresponding information is edited together with possible combinations and resultants thereof.

On the basis of that, the mode of functioning of the invention is automatically set in motion, from filling-out of the questionnaire by the reader to production of his personalized work.

1. A method for producing a personalized information support in which:
1) a thematic matrix of groups of predetermined responses (2) is produced;
2) a corresponding thematic matrix (3) of multiple-choice questions is associated with this matrix of groups of responses;
3) a database of information (4) associated with said responses and with the predetermined combinations of these responses is produced;
4) the responses (5) of a person (6) are entered on a data-input terminal (7) associated with said information database;
5) in a computer (8), said responses and the database information (9) are combined; and
6) from the database information, an extraction program (10) extracts information relating to the responses entered and to combinations (11) thereof; and
7) in the computer, an assembly program (12) groups together the extracted information in order to convert into said information support (1).

2. The method as claimed in claim 1, in which the association of question (2) and response (3) matrices takes the form of a multiple-choice questionnaire.

3. The method as claimed in claim 2, in which the multiple-choice questionnaire is filled out by checking the box that corresponds to the chosen response.

4. The method as claimed in any one of claims 1 to 3, in which the responses (5) entered on a data terminal originate from input on a paper form.

5. The method as claimed in any one of claims 1 to 3, in which the responses (5) entered on a data terminal originate from input on a computer.

6. The method as claimed in one of claims 1, 2, 3, or 5, in which the responses (5) entered on a data terminal originate from input on an internet site.

7. The method as claimed in one of claims 1, 2, 3, 4, 5, or 6, in which the information support produced is a paper book.

8. The method as claimed in one of claims 1, 2, 3, 4, 5, or 6, in which the support produced is an electronic book.

9. The method as claimed in claim 1, 2, 3, 4, 5, or 6, in which the information support produced is a downloadable computer file.

10. The method as claimed in any one of the preceding claims, in which the assembly program (12) uses occupation iconography adapted to the meaning of the text and to the dimensions of the spaces to be covered.
